(19) United States
(12) Patent Application Publication
(10) Pub. No.: US 2024/0410260 A1
(43) Pub. Date: Dec. 12, 2024

(54) FORMULATIONS OF SELF-WEIGHTED AND WEIGHTED FLUIDS AND USE THEREOF

(71) Applicant: PETRÓLEO BRASILEIRO S.A. – PETROBRAS, Rio de Janeiro (BR)

(72) Inventors: Nilson Jose DENADAI, Santos (BR); Alexandre Zacarias IGNACIO PEREIRA, Rio de Janeiro (BR); Edielton DOMINGOS DOS SANTOS, Macaé (BR); Fabio FABRI, Santos (BR); Flavio BITTENCOURT DA CRUZ, Rio de Janeiro (BR)

(21) Appl. No.: 18/632,504

(22) Filed: Apr. 11, 2024

(30) Foreign Application Priority Data
Jun. 9, 2023 (BR) 1020230113966

(51) Int. Cl. E21B 43/25; C09K 8/86

(52) U.S. Cl. CPC E21B 43/25; C09K 8/86; C09K 2208/32

(57) ABSTRACT

The present disclosure relates to formulations of self-weighted and weighted stimulation fluids, such as acids or chelators, for the stimulation of the oil wells through gravitational positioning.

### FIELD OF THE DISCLOSURE

The present disclosure pertains the field of oil well stimulation, more precisely in the field of well drilling and completion, and refers to formulations of self-weighted and weighted stimulation fluids, acids or chelators, to improve the stimulation of the oil wells through gravitational positioning.

### BACKGROUND

Since the beginning of the development of the pre-salt carbonate fields of the Santos Basin, several optimizations have been implemented in the well configurations and technological processes involved in their construction. Currently, the most common well completion configuration consists of selective open-hole completion in 2 or 3 distinct zones.

Concomitantly with these innovations, the reservoir stimulation activity implemented several unusual solutions, both in terms of equipment and the chemicals used, with weighted acidic systems being developed, a technique hitherto not explored by service companies or other operators and which is the subject of this patent application.

After completion of drilling, or even after perforating, wells normally do not have sufficient injectivity to carry out acidic treatment, since the drilling fluid causes intentional damage to the pores of the formation, which is necessary to safely complete the construction of the well. To enable the injection of the acidic treatment into the carbonate formations, it was common to use blasting equipment inside the well, called “coiled tubing”, especially in the initial phase of the acidic treatment. This equipment was positioned inside the well, an isolation plug at the end of the production/injection string was removed, and the acidic treatment was blasted at the base of the lower zone. This step aimed at promoting an improvement in the injectivity of the reservoir, thus allowing the massive acidic treatment (main treatment) to be carried out later, by direct injection through the production string at high flow rates (bull heading), after the installation of the final equipment of the reservoir. completion, including the Wet Christmas Tree (WCT).

As disadvantages arising from the use of coiled tubing, one can mention the long time required for its implementation, having a financial impact on the construction of wells, in addition to implying operational and safety risks. Thus, an alternative was presented for positioning stimulation fluids in order to promote the creation of initial injectivity without the need for the use of coiled tubing, using the completion equipment's own seating string, using acidic systems of low reactivity and low corrosivity. This new step began to be carried out at an earlier step of completion than was normally carried out, with the well still without the Wet Christmas Tree (WCT) being installed, which, for this reason, became known as “Early Stimulation”.

Concomitantly, the use of weak acids and chelators was introduced with the aim of creating zones with moderate injectivities, sufficient only to start the main acidic treatment, avoiding the need for injections above the reservoir fracture pressures, or the induction of very high losses to the formation. These precautions have become necessary, since the early stimulation occurs without all safety equipment being permanently installed in the well, and it is therefore not desirable to have a very high level of fluid loss to the formation.

This new form of acid positioning, using the work string, had the disadvantage of not being able to reach the base of the lower zone of the well, as was done when using coiled tubing. This limitation raised doubts about a possible loss of quality of the acidic treatment in the lower interval, which could harm the well accumulated production. Therefore, an alternative was sought to allow the creation of injectivity also at the base of the lower zone of the wells, avoiding the use of coiled tubing. Then, the use of weighted acids began, seeking to carry out “Gravitational Positioning” at the base of the lower reservoir, through the percolation of the acid through the fluid present in the well, which has a lower density.

To try to solve possible cases of lack of injectivity in the lower interval of the well, it was proposed to use weighted EDTA, so that it could decant and reach the base of the reservoir. Studies of EDTA formulations and other weighted acidic systems were further initiated.

Fluid weighting is a concept widely used in other well construction areas, such as drilling, cementing and workovers, where various solids such as barite, bentonite, limestone, or soluble salts are commonly used for this purpose; however, it was rarely or almost never used in acidic stimulation of oil wells.

The use of weighting agents in acidic stimulation activity is incipient around the world, with treatments in the Pre-Salt being an exception, due to their use for the positioning of EDTA. Several other weighted formulations are being tested for field applications in the different phases of the acidic treatments.

Gravitational Positioning, as an auxiliary stimulation technique, uses weighted acidic fluids in order to reach greater depths from the injection point, presents a great advantage, which is to work on a new approach that depends less on the characteristics of the formation (porosity and permeability) and the effect of chemical or physical diverters, with the aim of reaching certain regions of lower permoporous quality, where there are difficulties and/or doubts during treatments, as it is a purely physical phenomenon that occurs inside the well and not through the formation porous matrix. This does not mean renouncing diverters or already-currently-used solutions, but it is a complementary technique, which aims at improving and associate with the effects observed with the diversion that occurs in training.

It is worth highlighting that the use of saturated or supersaturated fluids of sodium chloride or ammonium chloride has already been carried out, with the aim of obtaining a diversion effect, but not to promote an increase in density of the fluid of interest. As of 2015, Petrobras began using chelators and weighted acetic acid in isolated steps of the operations, such as in the creation of injectivity; however, they are not yet predominant in the main acidic treatment.

FIG. 1 schematically exemplifies the evolution of the stimulation process as mentioned previously. FIG. 1A shows the creation of injectivity using coiled tubing, reaching the base of the lower reservoir, in order to allow the main treatment to be taken to this zone, as well as using it to treat all other intervals later. 15% hydrochloric acid was preferably used, with 10% acetic acid being reserved for wells with high temperatures. This sequence required significant operational time, in addition to implying greater risks associated with the tools being stuck and consequent fishing. A survey, carried out in our database, shows that the average time for stimulation operations was around five rig days for its execution. Cases are reported in which there were operational problems, such as: lack of coiled tubing equipment, waiting for favorable weather conditions for operations, equipment failures, leaks, accidents, wire equipment and the coiled tubing itself being stuck, events that caused negative impacts during the construction of several wells. Table 1 details the average times for each step of completion and stimulation, according to these assumptions.

From 2015 onwards, not only as a way to avoid the use of coiled tubing equipment, but also to improve the quality of acidification in the upper zones of the wells, the use of an ethylenediaminetetraacetic acid (EDTA) solution began in a step prior to that usually used for stimulation. This positioning began to be carried out by circulation at the end of the string, with return to the surface through the annulus of the upper zonas of the well, before the packers were placed, thus allowing a better distribution of the main acidic treatment in this zone. However, some doubts began to concern the injectivity conditions of the lower interval, as well as a possible harm to the distribution of treatment in this region (FIG. 1B), since the EDTA circulation point was close to the base of the upper interval; i.e., above the lower interval.

The sequence of operational steps and respective completion and stimulation times of a typical Pre-Salt well, before the modifications described, are shown in detail in Table 1, below:

TABLE 1
Average operational times of the completion and stimulation
step with FT and acidification in the post WCT phase

| | | Average |
|---|---|---|
| | | Time |
| Id | Task Name | (hour) |
| 1 | Navigation | 10 |
| 2 | Steps prior to stimulation | 15.5 |
| 3 | Steps prior to stimulation | 79 |
| 4 | Steps prior to stimulation | 94 |
| 5 | Steps prior to stimulation | 23.5 |
| 6 | Steps prior to stimulation | 119 |
| 7 | Steps prior to stimulation | 72.5 |
| 8 | Steps prior to stimulation | 74 |
| 9 | Steps prior to stimulation | 8 |
| 10 | Steps prior to stimulation | 16 |
| 11 | Steps prior to stimulation | 68 |
| 12 | Steps prior to stimulation | 25 |
| 13 | Steps prior to stimulation | 37.5 |
| 14 | Steps prior to stimulation | 5 |
| 15 | Steps prior to stimulation | 2 |
| 16 | Steps prior to stimulation | 6 |
| 17 | Steps prior to stimulation | 25.5 |
| 18 | Steps prior to stimulation | 14 |
| 19 | Installation of WCT | 25 |
| 20 | Chemical Treatment - Loss Zone | 54 |
| 21 | Direct injection into the lower zone | 10 |
| 22 | Chemical Treatment - Direct injection | 6 |
| | into the upper zone | |
| 23 | Injection test in upper zone | 5 |
| 24 | Injection test in lower zone | 10 |
| 25 | Steps after stimulation | 13 |
| 26 | Steps after stimulation | 32 |
| 27 | End of well completion | 0 |
| total | CI Completion Activities 8½″ (21.59 | 923.5 h |
| | cm). PAB installation, well reentry, | |
| | open hole lower completion installation, | |
| | CI installation, TH installation, WCT | |
| | installation, acidification and mini-TI | |
| | in both zones. | |

According to the sequence shown in Table 1, the average time required to complete a typical Pre-Salt well would be on the order of 923.5 h, or 38.5 days. It can be seen that these times are greatly impacted by the need to use the coiled tubing equipment to stimulate the well (70 h) and by the installation of the WCT (12 to 15 days) with the rig itself, and only after installing the WCT the main stimulation was performed with a stimulation boat connected to the rig. The elimination of the need to use coiled tubing allowed acidification operations to have rig time reduced to approximately 24 hours, and WCT installation time to be completely removed from the scope of the completion rigs, once this equipment began to be installed by a smaller vessel, a boat called SESV, a Submarine Equipment Support Vessel, which is dedicated especially to this function at Petrobras.

### RELATED ART

Document US2021324260 discloses mixtures of chelating acids for stimulating a subterranean formation, methods of using mixtures of chelating acids, and hydrocarbon wells that include mixtures of chelating acids. Such a document proposes the addition of chelators (including EDTA) to acidic mixtures (e.g., HCl and HF) for well stimulation, in order to reduce the potential for scale precipitation. The presence of the chelator can also decrease the reaction rate of the mixture of acids with the mineralogy of the formation, allowing the mixture of chelating acids to further penetrate the fracture and porous network of the formation.

Document WO2008139164, in turn, refers to methods of treating a portion of a matrix of a subterranean formation in a pre-existing fracture or perforation, to increase permeability and production. The method comprises, among other steps, forming or supplying a treatment fluid comprising: (i) water; (ii) a chelating agent capable of forming a heterocyclic ring that contains a metal ion bonded to at least two non-metal ions; and (iii) a viscosity increasing agent. Although the chelating agent may be EDTA, the treatment fluid uses a polymeric viscosity increaser, which, therefore, does not include or anticipate the increase in density of the composition by the addition of salts, as described in the present disclosure.

Documents US2017044884 and US2020079989 disclose the application of the chelating function of EDTA in other fluids applicable to the different steps of the life cycle of an oil well.

### SUMMARY

The present disclosure aims at proposing formulations of self-weighted and weighted fluids, such as EDTA and citric acid, for the stimulation of the oil wells through gravitational positioning.

### BRIEF DESCRIPTION OF THE DRAWINGS

FIG. 1 shows the evolution of the well construction model and its stimulation, wherein 1A) refers to blasting at the base with coiled tubing; 1B) refers to the circulation of EDTA through the base of the upper zone of the well; AND 1C) refers to the circulation of weighted EDTA at the base of the upper interval of the well.

FIG. 2 corresponds to the illustrative image of the occurrence of percolation of a weighted fluid over one of lower density, in which the colors indicate the variation in concentrations after a certain time.

FIG. 3 shows results of a CFD computational simulation of the concentration profile at the base of the lower perforation after positioning 0.1 M EDTA, as a function of elapsed time. The test was carried out after modeling the simulator with verification of the mesh, flow regimes, injection flow rates, EDTA concentrations, viscosities, and two turbulence models.

FIG. 4 presents the density gradient of citric acid solutions in three different solvents, that is, in industrial water, sodium chloride and calcium chloride. The variation in density was measured as a function of the molarity of citric acid in each of them.

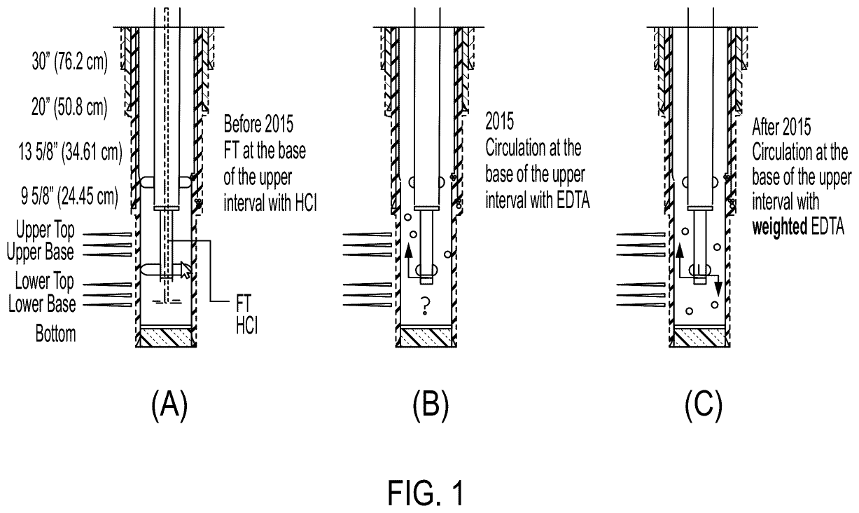

### DETAILED DESCRIPTION

The present disclosure refers to formulations of self-weighted and weighted fluids, containing citric acid and the EDTA chelator as active ingredients, for the stimulation of the oil wells through gravitational positioning. These formulations are presented below:

### Weighted Citric Acid Formulations

TABLE 2
Citric acid solution in industrial water (self-weighted)

| | | | | Density | |
|---|---|---|---|---|---|
| Product | Concentration | | Function | (g/cm³) | pH |
| Citric acid | 0.1 to 3.7 | | Acid and Self- | 1.005 to | 2.2 to |
| | molar | | Weighting agent | 1.279 | 0.36 |
| Industrial | q.s. | | Solvent | N/A | N/A |
| water | | | | | |
| Corrosion | 0.3% | (v/v) | Corrosion | N/A | N/A |
| inhibitor | | | inhibitor | | |
| Emulsion | 0.3% | (v/v) | Emulsion | N/A | N/A |
| preventer | | | preventer | | |
| Butyl glycol | 0 to 10% | (v/v) | Wettability | N/A | N/A |
| | | | inverter | | |

The density and pH values refer to the binary mixture of citric acid in industrial water only, without the addition of other additives. It is considered that variations due to the addition of these do not cause significant changes in the densities of interest.

TABLE 3
Citric acid solution in saturated sodium chloride brine

| | | | | Density | |
|---|---|---|---|---|---|
| Product | Concentration | | Function | (g/cm³) | pH |
| Citric acid | 0.1 to 3.63 | | Acid | 1.2 to | 0.58 |
| | molar | | | 1.366 | to −0.86 |
| NaCl brine | q.s. | | Weighting agent | 1.19 | N/A |
| (saturated) | | | | | |
| Industrial | q.s. | | Diluent | N/A | N/A |
| water | | | | | |
| Corrosion | 0.3% | (v/v) | Corrosion | N/A | N/A |
| inhibitor | | | inhibitor | | |
| Emulsion | 0.3% | (v/v) | Emulsion | N/A | N/A |
| preventer | | | preventer | | |
| Butyl glycol | 0 to 10% | (v/v) | Wettability | N/A | N/A |
| | | | inverter | | |

The density and pH values refer to the binary mixture of citric acid in saturated sodium chloride solution (NaCl brine) only, without the addition of other additives. It is considered that variations due to the addition of these do not cause significant changes in the densities of interest.

Industrial water can be used to obtain solutions with densities lower than the maximum indicated, according to operational needs.

TABLE 4
Citric acid solution in saturated calcium chloride brine

| | | | | Density | |
|---|---|---|---|---|---|
| Product | Concentration | | Function | (g/cm³) | pH |
| Citric acid | 0.1 to 3.39 | | Acid | 1.39 to | −1.5 |
| | molar | | | 1.466 | to −2.0 |
| CaCl₂ brine | q.s. | | Weighting | N/A | N/A |
| (saturated) | | | agent | | |
| Industrial | q.s. | | Diluent | N/A | N/A |
| water | | | | | |
| Corrosion | 0.3% | (v/v) | Corrosion | N/A | N/A |
| inhibitor | | | inhibitor | | |
| Emulsion | 0.3% | (v/v) | Emulsion | N/A | N/A |
| preventer | | | preventer | | |
| Butyl glycol | 0 to 10% | (v/v) | Wettability | N/A | N/A |
| | | | inverter | | |

The density and pH values refer to the binary mixture of citric acid in saturated calcium chloride solution (CaCl2) brine) only, without the addition of other additives. It is considered that variations due to the addition of these do not cause significant changes in the densities of interest.

Industrial water can be used to obtain solutions with densities lower than the maximum indicated, according to operational needs.

### Self-Weighted EDTA Formulation

TABLE 5
EDTA Solution in Industrial Water (self-weighted)

| | | | Density | |
|---|---|---|---|---|
| Product | Concentration | Function | (g/cm³) | pH |
| EDTA | 0.1 to 1.35 | Chelator and | 1.005 to | 4 to 12 |
| | molar | Self-Weighting | 1.279 | |
| | | agent | | |
| Industrial | q.s. | Solvent | N/A | N/A |
| water | | | | |
| HCl 32% | q.s. | pH adjustment | N/A | 5 to 12 |
| NaOH | q.s. | pH adjustment | N/A | 5 to 12 |
| Corrosion | 0.3% (v/v) | Corrosion | N/A | N/A |
| inhibitor | | inhibitor | | |
| Emulsion | 0.3% (v/v) | Emulsion | N/A | N/A |
| preventer | | preventer | | |

The density and pH values refer to the binary mixture of EDTA in industrial water only, without the addition of other additives. It is considered that variations due to the addition of these do not cause significant changes in the densities of interest.

The EDTA concentration most used in pre-salt operations is in the order of 0.35 M, with a final density of 8.6 ppg or 1.03 g/cm³ obtained when prepared exclusively with industrial water.

### Weighted EDTA Formulation in Saturated Sodium Chloride Brine

TABLE 6
EDTA solution in sodium chloride brine

| | | | Density | |
|---|---|---|---|---|
| Product | Concentration | Function | (g/cm³) | pH |
| EDTA | 0.1 to 1.35 | Chelator and | 1.005 to | 4 to 12 |
| | molar | Self-Weighting | 1.279 | |
| | | agent | | |
| NaCl brine | quantum satis | Solvent | 1.19 | N/A |
| (saturated) | (q.s.) | | | |
| HCl 32% | q.s. | pH adjustment | N/A | 5 to 12 |
| NaOH | q.s. | pH adjustment | N/A | 5 to 12 |
| Corrosion | 0.3% | Corrosion | N/A | N/A |
| inhibitor | volume/volume | inhibitor | | |
| | percentage | | | |
| | (v/v) | | | |
| Emulsion | 0.3% (v/v) | Emulsion | N/A | N/A |
| preventer | | preventer | | |

The density and pH values refer to the binary mixture of EDTA in saturated sodium chloride solution (NaCl brine) only, without the addition of other additives. It is considered that variations due to the addition of these do not cause significant changes in the densities of interest.

The EDTA concentration most used in Pre-Salt operations is in the order of 0.35 MI, obtaining a final density of 10.2 ppg or 1.22 g/cm³, when prepared from saturated sodium chloride brine.

### Technological Aspects

In order to plan properly, in order to achieve success in the use of chelating systems and weighted weak acids, it is imperative that the “segregation/decantation” occurs within normal operating times, which is a few hours, so to optimize treatment of the lower interval. There was doubt about the possibility of a miscible fluid percolating through another with lower density, that is, the decantation of the acidic system by the fluid that fills the well. Much was discussed about the nature of the phenomena that would prevail, such as the diffusivity and the dilution of the chemical species in contact, the predominant flow regime, the contact surface, the well geometry, viscosity and pressure losses, until it was concluded for the feasibility of the proposed technique.

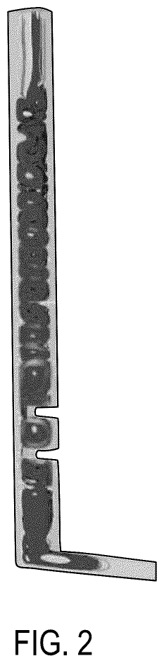

In order to objectively clarify these issues, modeling studies in Computational Fluid Dynamics (CFD) were initiated. FIG. 2 illustrates the occurrence of the percolation phenomenon, where the simulation shows that the concentration of EDTA at the base of the zone increases with time, while at the top it decreases as expected, thus showing that the developed CFD model was suitable for the purpose of the present disclosure.

The initial objective was to determine the time required for a weighted fluid 1 (lb/gal) (≈0.12 g/cm³) above the well fluid to migrate over an interval of 100 meters. After developing the algorithm, the first hypothetical case of interest was simulated, analogous to the conditions normally found in operations. It was then considered the positioning of 100 bbl (15.9 m3) of EDTA with a density of 1 lb/gal (1 ppg≈0.12 g/cm³) above the fluid system present in the well, which should overcome a height of 100 m. The result obtained was a time of around 50 minutes to reach the base of the interval, a very encouraging result, since operational times are significantly longer.

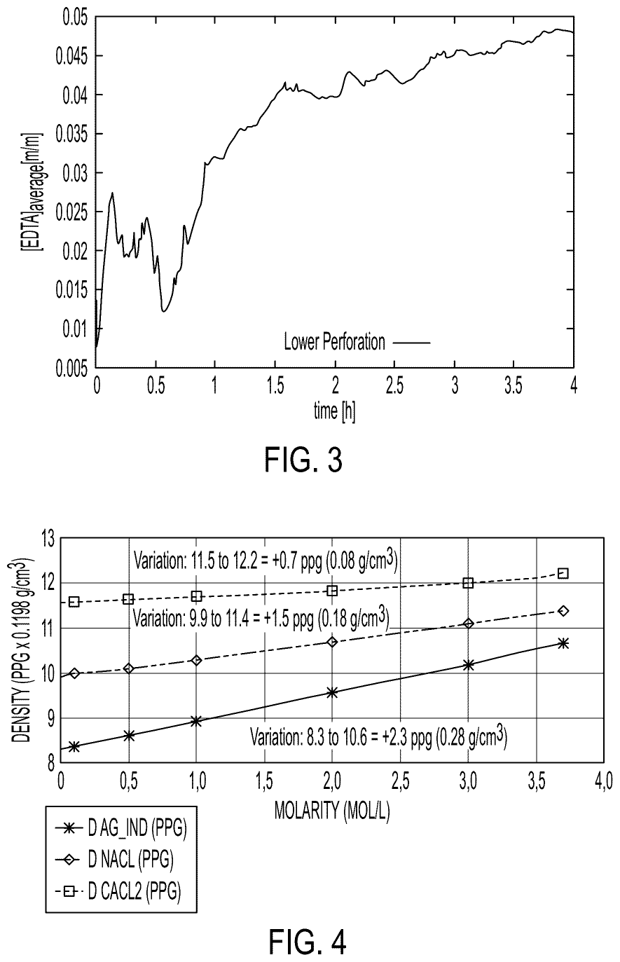

A second battery of simulations was carried out with the developed CFD model, considering a density difference of 0.4 ppg (lb/gal) (0.05 g/cm³) and a height to be overcome also of 100 m. FIG. 3 graphically shows the results of this simulation, and, after 4 hours, the concentration in the base is equivalent to 0.05 M; that is, 50% of the initial concentration of used EDTA (pumping concentration), so for a density difference of 0.4 lb/gal (0.05 g/cm³). This result corroborates the use of the Gravitational Positioning technique for well stimulation.

However, it is worth highlighting that due to limitations in the availability of materials and degrees of solubility, in practice, it is difficult to obtain density differences of the order of 1 ppg (0.12 g/cm³), especially in fields that still preserve the original reservoir pressure, normally close to 9.9 to 10 ppg (1.19 to 1.20 g/cm³). The weighting obtained only by adding EDTA, or combined with the base brine of the used completion fluid, requires several tons of EDTA and concentrations around 40%, making it difficult to achieve. Therefore, a new simulation was carried out considering a difference in densities of the order of 0.4 ppg (0.05 g/cm³). In this way, the result obtained was 4 h for migration, which is also a time scale compatible with field operations, definitively making the technique viable.

In parallel, several tests were carried out to determine the properties of the EDTA solutions and their mechanism of action, such as attack on test plugs, compatibility tests with different brines, optimum pH, viscosity, maximum concentrations without showing precipitation, and many others. It was found that it is possible to obtain EDTA solutions above 10 ppg (1.20 g/cm³) only with EDTA in industrial water in a stable form. The disadvantage of the systems using EDTA lies mainly in their low solubility in acidic pH. It follows that it is possible to use EDTA to weight the solution itself associated with salts such as sodium chloride, but it is not suitable for use in combination with other acids.

In the survey as to weak acids, when replacing acetic acid, citric acid was evaluated, which acts as a (limited) chelator, having the advantage that, with a decrease in pH, it becomes more soluble, and citric acid can be considered as a weighting agent for other acids, and together with other salts to enhance weighting.

Laboratory tests presented in Table 7 showed a solubility of 127 g/100 ml in distilled water (industrial water), with little reduction in solubility in a saturated environment in sodium chloride (125 g/100 ml) and, to a lesser extent, in calcium chloride brine (107 g/100 ml), highlighting that no incompatibility with calcium was observed, with the formation of an insoluble citrate.

TABLE 7
Solubility of citric acid in different media

| | | M | Solubility | | |
|---|---|---|---|---|---|
| Solvent | % M/M | (mol/L) | (g/100 ml) | Density | pH |
| Industrial Water | 41.55 | 3.7 | 127.86 | 1.28 | 0.36 |
| NaCl Brine | 41.10 | 3.63 | 125.59 | 1.37 | −0.86 |
| CaCl₂ Brine | 39.49 | 3.39 | 107.67 | 1.47 | −2 |

Thus, it is possible to verify a substantial increase in density, ranging from 1.28 g/cm³ from industrial water to 1.47 g/cm³, using CaCl2) brine as the base fluid. FIG. 4 exemplifies the weight variation in each medium tested, in which the variation in distilled water is greater.

As a field test (Table 8), a reduced-scale test was used in a typical Pre-Salt well, WAG (Water Alternate Gas) injection well, with intelligent completion of 2 zones, where the lower zone corresponded to an interval of 329 meters, with worse permoporous conditions when compared to the upper zone (length of 53 meters), in which it was estimated that it would be very difficult to stimulate the interval.

TABLE 8
Field tests using weighting of the acidic systems
Lower Zone

| | | | | Maximum | |
|---|---|---|---|---|---|
| | | Weight | Volume | Flow Rate | |
| | | (lb/gal) | (bbl) | (bbl/min) | |
| | | (×0.1198 | (×0.159 | (×0.159 | Time |
| Zone | Fluid | g/cm³) | m³) | m³/min) | (min) |
| I | Acetic Acid 10% | 9.8 | 263 | 5 | 53 |
| I | Diverter POL 2.5% | 8.5 | 85 | 5 | 30 |
| I | Acetic Acid 10% | 9.8 | 263 | 5 | 53 |
| I | Diverter POL 2.5% | 8.5 | 85 | 5 | 17 |
| I | Acetic Acid 10% | 9.8 | 345 | 5 | 69 |
| I | Diverter POL 2.5% | 8.5 | 85 | 5 | 17 |
| I | Acetic Acid 10% | 9.9 | 345 | 10 | 35 |
| I | Citric Acid 20% (1 | 10.1 | 50 | 10 | 5 |
| | molar) | | | | |
| I | Hydrochloric Acid 15% | 8.5 | 167 | 25 | 7 |
| I | Diverter POL 2.5% | 8.5 | 171 | 25 | 7 |
| I | Hydrochloric Acid 15% | 8.9 | 335 | 25 | 13 |
| I | Emulsified | 8.5 | 546 | 25 | 22 |
| | Hydrochloric Acid 15% | | | | |
| I | Hydrochloric Acid 15% | 8.9 | 335 | 25 | 13 |
| I | Diverter POL 2.5% | 8.5 | 171 | 25 | 7 |
| I | Hydrochloric Acid 15% | 8.9 | 335 | 25 | 13 |
| I | Diverter POL 2.5% | 8.5 | 256 | 25 | 10 |
| I | Hydrochloric Acid 15% | 8.9 | 502 | 25 | 20 |
| I | FSAL Na+ | 8.5 | 550 | 25 | 0 |
| | | | 4890 | | 391 |

The weight of fluid used in the workover was 9.4 lb/gal (1.13 g/cm³). Thus, acetic acid cushions in brine were prepared to obtain a final weight of 9.8 lb/gal (1.17 g/cm³). Interspersed with the treatment, citric acid was used in sodium chloride brine weighing 10 lb/gal (1.20 g/cm³). The sequence had the objective of carrying out a progressive treatment (from the weakest acid to the strongest) using the concept of gravitational segregation, increasing the density of the solutions during the treatment. It was not possible to weight the hydrochloric acid cushions in the test due to laboratory tests still being carried out and the availability of citric acid in the workover rig.

A good result was obtained showing the viability of gravitational segregation, due to the feasibility of the technique, thus showing great potential for field applications. Both zones were stimulated and showed good injectivities at the end of the treatment, with the selectivity between zones being preserved. Table 9 summarizes the data obtained.

TABLE 9
Results obtained after treatment

| | | | II_{20 min} | | |
|---|---|---|---|---|---|
| | | Interval | (m³/d)/ | | Kh |
| Interval | Zone | (extension) | (kgf/cm²) | RD | (mD · m) |
| Upper | S | 5252.7 to 5305.7 m | 43.7 | 0.81 | 7120 |
| | | (53.0 m) | | | |
| Lower | I | 5337.6 to 5667.0 m | 107.9 | 0.52 | 8170 |
| | | (329.4 m) | | | |

Considering the technology developed in the present disclosure to be pioneering, its use brings numerous benefits; for example, the cost reduction may be due to the possibility of using the technique to replace mechanical equipment for positioning fluids, such as valves, coiled tubing, or washing tubes. Another added advantage is the possibility of improving the diversion of treatments, which implies greater productivity and an improvement in the well recovery factor.

The use of weighted acidic fluids was originally aimed at stimulating oil wells in Pre-Salt carbonate formations, and can then be extended to other types of horizontal, directional or vertical sandstone and carbonate well completions.

1. A self-weighted fluid formulation comprising:
0.1 to 3.7 molar of an acid, the acid including citric acid;
one or more solvents quantum satis (q.s.), the one or more solvents including industrial water;
0.3% volume/volume percentage (v/v) of a corrosion inhibitor;
0.3% v/v of an emulsion preventer; and
0 to 10% v/v of a wettability inverter, the wettability inverter including butyl glycol.

2. The self-weighted fluid formulation according to claim 1, wherein the binary mixture of citric acid in the industrial water has a density of 1.005 to 1.279 gram per cubic centimeter (g/cm³), and a pH value of 2.2 to 0.36.

3. A weighted fluid formulation comprising:
0.1 to 3.63 molar of an acid, the acid including citric acid;
one or more weighting agents q.s., the one or more weighting agents including saturated NaCl brine;
diluent q.s., the diluent including industrial water;
0.3% v/v of a corrosion inhibitor;
0.3% v/v of an emulsion preventer; and
0 to 10% v/v of a wettability inverter, the wettability inverter including butyl glycol.

4. The weighted fluid formulation according to claim 3, wherein the binary mixture of citric acid in saturated sodium chloride solution has a density of 1.2 to 1.366 g/cm³, and a pH value of 0.58 to −0.86.

5. The weighted fluid formulation according to claim 3, wherein the saturated sodium chloride brine has a density of 1.19 g/cm³.

6. A weighted fluid formulation comprising:
0.1 to 3.39 molar of an acid, the acid including citric acid;
weighting agent q.s., the weighting agent including saturated CaCl2) brine;
diluent q.s., the diluent including industrial water;
0.3% v/v of a corrosion inhibitor;
0.3% v/v of an emulsion preventer; and
0 to 10% v/v of a wettability inverter, the wettability inverter including butyl glycol.

7. The weighted fluid formulation according to claim 6, wherein the binary mixture of citric acid in saturated calcium chloride solution has a density of 1.39 to 1.466 g/cm³, and a pH value of −1.5 to −2.0.

8. A self-weighted fluid formulation comprising:
0.1 to 1.35 molar of a chelator, the chelator including ethylenediaminetetraacetic acid (EDTA);
solvent q.s., the solvent including industrial water;
pH adjusters q.s., the pH adjusters including HCl 32% and NaOH;
0.3% v/v of a corrosion inhibitor; and
0.3% v/v of an emulsion preventer.

9. The self-weighted fluid formulation according to claim 8, wherein the binary mixture of EDTA in industrial water has a density of 1.005 to 1.279 g/cm³, and a pH value of 4 to 12.

10. The self-weighted fluid formulation according to claim 8, wherein a total density of 1.03 g/cm³ is obtained when prepared exclusively with industrial water.

11. A weighted fluid formulation comprising:
0.1 to 1.35 molar of a chelator, the chelator including EDTA;
solvent q.s., the solvent including saturated NaCl brine;
pH adjusters q.s., the pH adjusters including HCl 32% and NaOH;
0.3% v/v of a corrosion inhibitor; and
0.3% v/v of an emulsion preventer.

12. The weighted fluid formulation according to claim 11, wherein the binary mixture of EDTA in saturated sodium chloride solution has a density of 1.005 to 1.279 g/cm³, and a pH value of 4 to 12.

13. The weighted fluid formulation according to claim 11, wherein the saturated sodium chloride brine has a density of 1.19 g/cm³.

14. The weighted fluid formulation according to claim 11, wherein a total density of 1.22 g/cm³ is obtained when prepared from saturated sodium chloride brine.

15. A method of use of a weighted fluid formulation, the method comprising:
(A) selecting a weighted fluid formulation, the selected weighted fluid formulation selected including one of the following:
(1) a weighted fluid formulation comprising: (a) 0.1 to 3.7 molar of an acid, the acid including citric acid, (b) one or more solvents quantum satis (q.s.), the one or more solvents including industrial water, (c) 0.3% volume/volume percentage (v/v) of a corrosion inhibitor; (d) 0.3% v/v of an emulsion preventer, and (e) 0 to 10% v/v of a wettability inverter, the wettability inverter including butyl glycol,
(2) a weighted fluid formulation comprising: (a) 0.1 to 3.63 molar of an acid, the acid including citric acid, (b) one or more weighting agents q.s., the one or more weighting agents including saturated NaCl brine, (c) diluent q.s., the diluent including industrial water, (d) 0.3% v/v of a corrosion inhibitor, (e) 0.3% v/v of an emulsion preventer, and (f) 0 to 10% v/v of a wettability inverter, the wettability inverter including butyl glycol,
(3) a weighted fluid formulation comprising: (a) 0.1 to 3.39 molar of an acid, the acid including citric acid, (b) weighting agent q.s., the weighting agent including saturated CaCl2) brine, (c) diluent q.s., the diluent including industrial water, (d) 0.3% v/v of a corrosion inhibitor, (e) 0.3% v/v of an emulsion preventer, and (f) 0 to 10% v/v of a wettability inverter, the wettability inverter including butyl glycol,
(4) a weighted fluid formulation comprising: (a) 0.1 to 1.35 molar of a chelator, the chelator including ethylenediaminetetraacetic acid (EDTA), (b) solvent q.s., the solvent including industrial water, (c) pH adjusters q.s., the pH adjusters including HCl 32% and NaOH, (d) 0.3% v/v of a corrosion inhibitor, and (e) 0.3% v/v of an emulsion preventer, or
(5) a weighted fluid formulation comprising: (a) 0.1 to 1.35 molar of a chelator, the chelator including EDTA, (b) solvent q.s., the solvent including saturated NaCl brine, (c) pH adjusters q.s., the pH adjusters including HCl 32% and NaOH, (d) 0.3% v/v of a corrosion inhibitor, and (e) 0.3% v/v of an emulsion preventer; and
gravitationally positioning the selected weighted fluid formulation into one or more oil wells so that the weighted fluid formulation at least partially assists with stimulation of geological surfaces within the one or more oil wells.
